(19) United States
(12) Patent Application Publication
(10) Pub. No.: US 2020/0340565 A1
(43) Pub. Date: Oct. 29, 2020

(54) GEAR TRANSMISSION SYSTEM EMBODYING A TWIN PITCHED COG BELT

(71) Applicant: Thomas Franklin Troester, Granger, IN (US)

(72) Inventor: Thomas Franklin Troester, Granger, IN (US)

(21) Appl. No.: 15/929,379

(22) Filed: Apr. 29, 2020

Related U.S. Application Data
(60) Provisional application No. 62/836,635, filed on Apr. 29, 2019.

(51) Int. Cl. F16H 35/06; F16H 55/17; F16H 57/00; F16H 1/20

(52) U.S. Cl. CPC F16H 35/06; F16H 55/17; F16H 1/24; F16H 1/20; F16H 57/0031

(57) ABSTRACT

A gear transmission system embodying a unique twin pitch belt is provided. The twin pitch belt provides external first pitch gear teeth and a second pitch gear teeth synchronously engaging a fixed housing gear teeth and output gear teeth, respectively. The first and second pitch gear teeth may have the same gear pitch if different number of teeth though offset by a distance relative to each other. The first and second pitch gear teeth have less teeth than the housing and output gear teeth, in turn twice countering the rotation of an input shaft operatively associated with the twin pitch belt, resulting in the output gear teeth rotating in the same direction as the input shaft.

### CROSS-REFERENCE TO RELATED APPLICATION

This application claims the benefit of priority of U.S. provisional application No. 62/836,635, filed 29 Apr. 2019, the contents of which are herein incorporated by reference.

### BACKGROUND OF THE INVENTION

The present invention relates to gear transmissions and, more particularly, to a gear transmission system embodying a unique twin pitched cog belt.

Traditional transmission systems embody a planetary gear train or worm drive gear arrangement, which are prone to backlash, have substantial mass, can produce noise, can require a relatively high amount of maintenance—e.g., lubrication—can be expensive and time-consuming to manufacture because of the inherent precision demanded of gear teeth enmeshment so that their pitch circles roll without slip.

As can be seen, there is a need for a gear transmission system embodying a unique twin pitched cog belt to increase systemic efficiency compared to the prior art. The gear transmission system of the present invention is a high ratio, minimal backlash, lite-weight, quiet operating, low maintenance, easy to manufacture and low-cost solution as compared to existing transmissions. The gear transmission system employs a unique twin pitched cog belt instead of gears that require lubrication and precision manufacturing. As opposed to current gear transmissions of same ratio reduction, which require many stages, which add weight and costs. The present invention can replace an existing planetary gear train and worm drive gear arrangement, wherein the design of the present invention is ⅕ the size and ¼ the weight for the same ratio and torque capacity. The present invention is colloquially known as a Telamonic™ transmission.

### SUMMARY OF THE INVENTION

In one aspect of the present invention, a gear transmission apparatus includes the following: an endless belt having an external surface; and a plurality of first pitch gear teeth and a plurality of second pitch gear teeth side by side along the external surface, wherein the pluralities of first and second pitch gear teeth have the same gear pitch but different number of teeth.

In another aspect of the present invention, a gear transmission system, includes the following: an input shaft; the above-mentioned apparatus operatively associated with said input shaft in such a way that rotation of the input shaft causes rotation of said apparatus; a plurality of bearing gear teeth engaging the plurality of first pitch gear teeth; and a plurality of output gear teeth engaging the plurality of second pitch gear teeth; a plurality of output gear splines operatively associated with the input shaft so as to rotate in the same direction thereof, wherein the plurality of output gear splines circumscribe the input shaft; and a drive unit operatively associated with the input shaft to rotate said apparatus, wherein the drive unit comprises a hub shaft supporting two diametrically opposing roller elements operatively an inner surface of the endless belt, wherein the two diametrically opposing roller elements elliptically deform the pluralities of first and second pitch gear teeth to engage the pluralities of bearing and output gear teeth, respectively and synchronously, wherein the pluralities of bearing and output gear teeth are internally oriented, wherein the pluralities of bearing and output gear teeth outnumber the pluralities of first and second pitch gear teeth, respectively.

These and other features, aspects and advantages of the present invention will become better understood with reference to the following drawings, description and claims.

### BRIEF DESCRIPTION OF THE DRAWINGS

FIG. 1A is a front perspective view of an exemplary embodiment of the present invention;

FIG. 1B is a front perspective view of an exemplary embodiment of the present invention (housing 10 hidden for clarity);

FIG. 2A is a rear perspective view of an exemplary embodiment of the present invention;

FIG. 2B is a rear perspective view of an exemplary embodiment of the present invention (the output gear 44 hidden for clarity);

FIG. 3 is an exploded perspective view of an exemplary embodiment of the present invention;

FIG. 4 is a section view of an exemplary embodiment of the present invention, taken along line 4-4 of FIG. 1A;

FIG. 5 is a section view of an exemplary embodiment of the present invention, taken along line 5-5 of FIG. 1B;

FIG. 6 is a section view of an exemplary embodiment of the present invention, taken along line 6-6 of FIG. 4, illustrating first pitch external teeth 41 of the twin pitch belt 40 and the housing gear teeth 14 (32:34);

FIG. 7 is a section view of an exemplary embodiment of the present invention, taken along line 7-7 of FIG. 4, illustrating the second pitch external teeth 42 of the twin pitch belt 40 and output gear teeth 46 of output gear 44 (31:33); and

FIG. 8 is a section view of an exemplary embodiment of the present invention, illustrating the rotation of drive shaft 18, which rotates rollers 28 on wings/flanges 20 and 22, rolling in the counter direction to rotatably engage the twin pitch belt 40 in the housing gear teeth 14 (as well as the output gear teeth 46, not shown in this Figure).

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gear transmission system embodying a unique twin pitch belt. The twin pitch belt provides external first pitch gear teeth and a second pitch gear teeth synchronously engaging a fixed housing gear teeth and output gear teeth, respectively. The first and second pitch gear teeth may have the same gear pitch though offset axially by a distance relative to each other. The first and second pitch gear teeth have less teeth than the housing and output gear teeth, in turn twice countering the rotation of an input shaft operatively associated with the twin pitch belt, resulting in the output gear teeth rotating in the same direction as the input shaft.

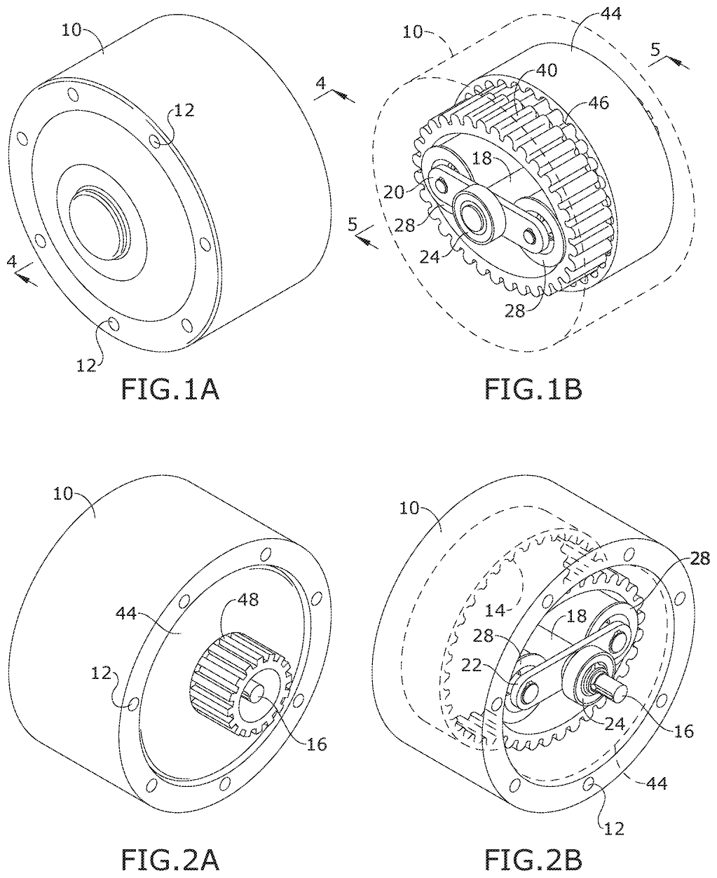

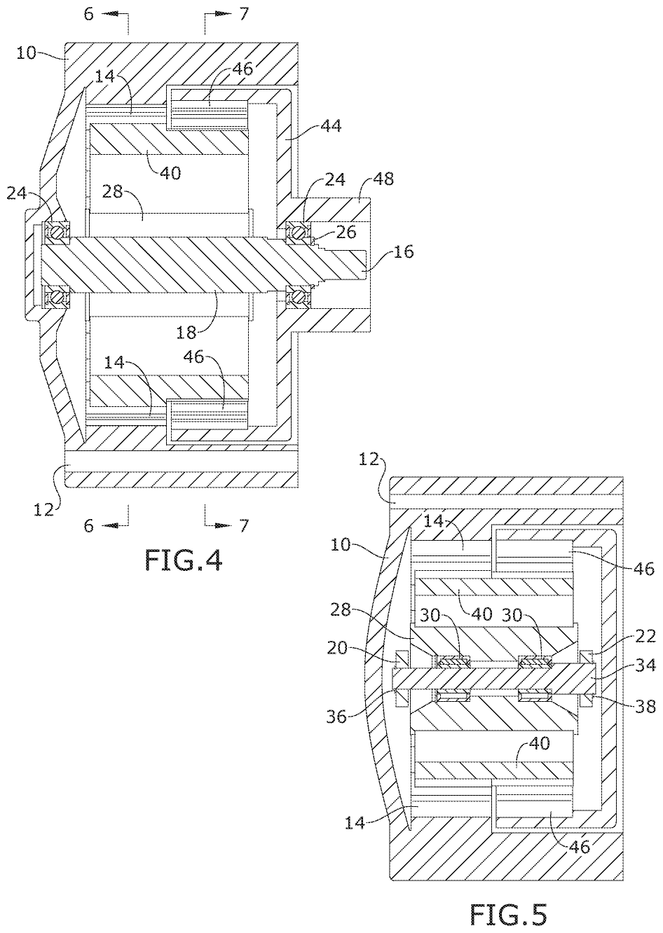

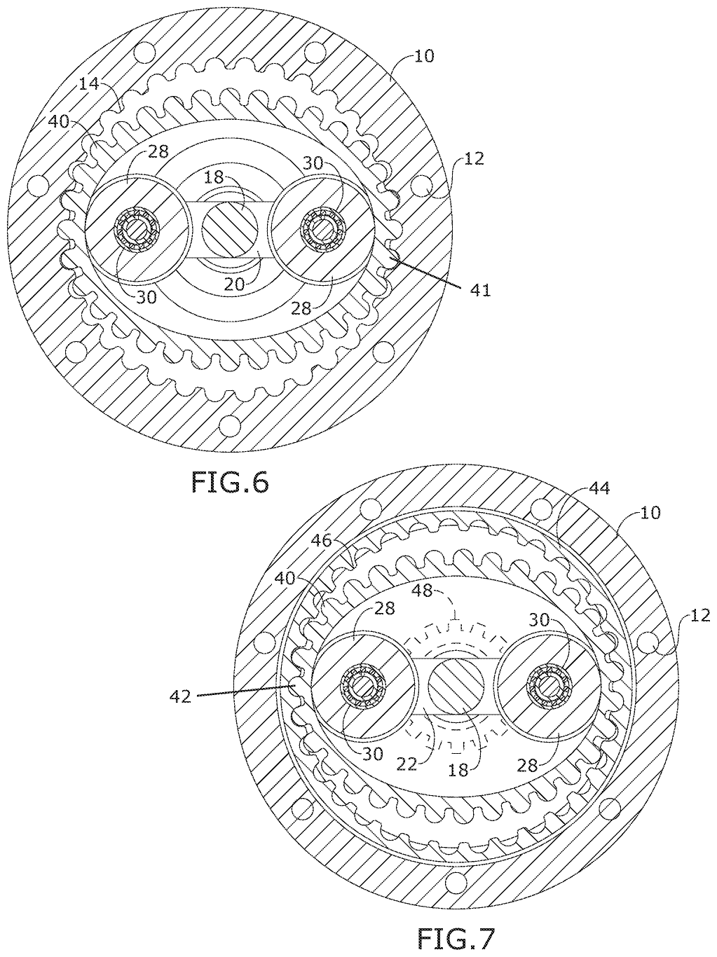

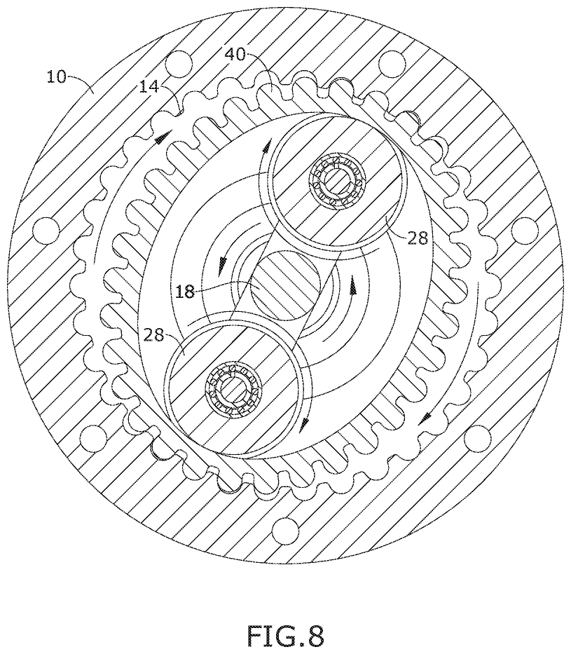

Referring to FIGS. 1A through 8, the present invention may include a twin pitch belt 40 operatively associated with a housing 10, an input shaft 16, and an output gear 44.

The housing 10 provides mounting holes 12 for preventing displacement thereof through mounting to a bearing surface. The mounting holes 12 may be disposed on a first end of the housing 10, while in one embodiment the input shaft 16 may be disposed on an opposing second end of the housing 10. Housing gear teeth 14 may be provided along an inner periphery of the housing 10 adjacent to the first end of the housing 10.

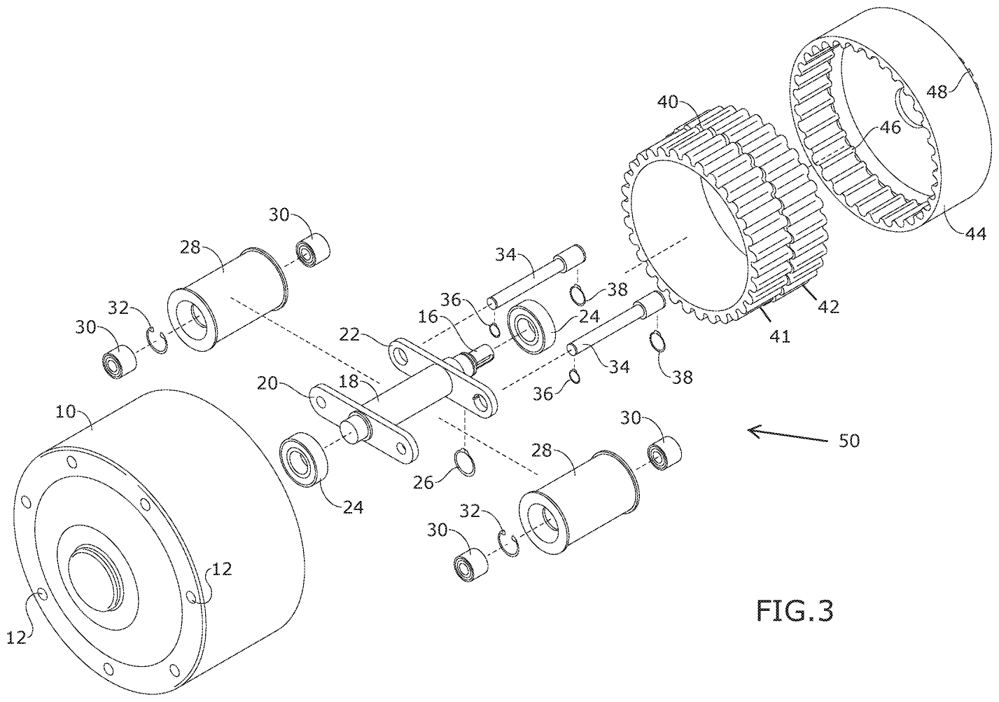

Referring to FIG. 3, in one embodiment, extending centrally through a compartment defined by said inner periphery of the housing 10 is a drive device 50. The drive device 50 may include a hub center shaft 18 having two rollers 28 diametrically opposed thereabout.

In certain embodiments, a first hub flange 20 and a second hub flange 22 may be spaced apart at adjacent ends of the hub center shaft 18; each hub flange 20 or 22 radially extending in diametrically opposing directions, with roller holes at each opposing distal end. Each pair of the first and second spaced apart roller holes facilitate a connection to a roller pin 34 by way of front and rear retaining clips 36 and 38 or the like. Each roller pin 34 operatively associates with a roller element 28 having roller bearings 30 and internal retaining clips 32 or the like. The hub center shaft 18 may also have anti-friction hub bearings 24 and retaining clips 26.

The hub center shaft 18 may operatively associate with the input shaft 16 so that when the input shaft 16 is rotated one revolution, the two roller elements 28 also complete one revolution while rotating about their axis (pins 34) in a counter direction. Said roller elements 28 are dimensioned and adapted to roll the flexible, external-tooth, synchronous twin pitch belt 40 which is synchronously in gear mesh with both the housing gear teeth 14 and internal ring output gear teeth 46 of the output gear 44.

The twin pitch belt 40 has an external surface providing, side-by-side, a first pitch gear teeth 41 (along a first portion of the external surface) and an offset second pitch gear teeth 42 (along a second portion of the external surface).

Since the first pitch gear teeth 41 are fewer in number than the housing gear teeth 14, one rotation of the input shaft 16 in turn results in the twin pitch belt 40 rotating opposite that of the input shaft 16 by the difference in number of teeth arc distance of the housing gear teeth 14 minus the first pitch gear teeth 41. Likewise, the second pitch gear teeth 42 is in gear mesh with output internal ring gear teeth 46, and the output internal ring gear 44 rotates opposite the twin pitch belt 40 and in turn in the same direction as the input shaft 16, since each rotation of the twin pitch belt 40 the output internal ring gear 44 rotates the arc distance in angular correspondence with the number of less teeth, thereby rotating the output splines 48 in the same direction as the input shaft 16.

The twin pitch belt 40, fitted onto the drive device 50, may be elliptically deformable such that the first pitch and second pitch external teeth 41 and 42 of the twin pitch belt 40 engage with the internal teeth housing gear teeth 14 and output gear teeth 46, respectively, along opposing areas of a major axis of the resulting ellipse. It is understood that the first and second pitch gear teeth 41 and 42 may not have the same number of teeth unless they are different pitch, but that they are offset from each other. In certain embodiment the offset is such that each first pitch gear tooth 41 is disposed between two adjacent second gear teeth 42, and vice versa. In other embodiments, the offset is less than half that of the pitch distance of two adjacent gear teeth 41 or 42.

A method of making the present invention may include the following. The machining of the steel, aluminum, iron or like-material parts is simple to manufacture with modern production machines. The gear teeth 14 and 46 of the housing 10 and output gear 44 are much easier to machine with less precision and less cost than traditional gears. The twin pitch belt 40 may be molded and reinforced with bidirectional or bid carbon or similar fiber reinforcement.

The gear transmission system disclosed above has the input and output on the same side due to one of many particular design applications. A design with the input on one side and output on other side is contemplated herein, though not shown in the Figures.

A method of using the present invention may include the following. The gear transmission system embodying a unique twin pitched cog belt may be provided. The gear transmission system may change speed or torque, and so can be used anywhere or any field of technology.

It should be understood by those skilled in the art that the use of directional terms such as first and second direction are used in relation to the illustrative embodiments as they are depicted in the figures, the first direction being toward the left of corresponding FIG. 1A, the second direction being toward the right of the same Figure.

It should be understood, of course, that the foregoing relates to exemplary embodiments of the invention and that modifications may be made without departing from the spirit and scope of the invention as set forth in the following claims.

What is claimed is:

1. An apparatus, comprising:
an endless belt having a surface; and
a plurality of first pitch gear teeth and a plurality of second pitch gear teeth side by side along the surface, wherein the pluralities of first and second pitch gear teeth have their gear pitch offset relative to each other.

2. A gear transmission apparatus, comprising:
an endless belt having an external surface; and
a plurality of first pitch gear teeth and a plurality of second pitch gear teeth side by side along the external surface, wherein the pluralities of first and second pitch gear teeth have their gear pitch offset relative to each other.

3. A gear transmission system, comprising:
an input shaft;
the apparatus of claim 1 operatively associated with said input shaft in such a way that rotation of the input shaft causes rotation of said apparatus;
a plurality of bearing gear teeth engaging the plurality of first pitch gear teeth; and
a plurality of output gear teeth engaging the plurality of second pitch gear teeth.

4. The gear transmission system of claim 3, further comprising:
a plurality of output gear splines operatively associated with the input shaft so as to rotate in the same direction thereof.

5. The gear transmission system of claim 4, wherein the plurality of output gear splines circumscribe the input shaft.

6. The gear transmission system of claim 3, further comprising:
a drive unit operatively associated with the input shaft to rotate said apparatus.

7. The gear transmission system of claim 6, wherein the drive unit comprises a hub shaft supporting two diametrically opposing roller elements operatively an inner surface of the endless belt.

8. The gear transmission system of claim 7, wherein the two diametrically opposing roller elements elliptically deform the pluralities of first and second pitch gear teeth to engage the pluralities of bearing and output gear teeth, respectively and synchronously.

9. The gear transmission system of claim 3, wherein the pluralities of bearing and output gear teeth are internally oriented.

10. The gear transmission system of claim 7, wherein the pluralities of bearing and output gear teeth outnumber the pluralities of first and second pitch gear teeth, respectively.
